(19) United States
(12) Patent Application Publication
(10) Pub. No.: US 2025/0123948 A1
(43) Pub. Date: Apr. 17, 2025

(54) DEBUGGING METHOD, IOT DEVICE, DEBUGGING SERVER AND DEBUGGING SYSTEM

(71) Applicant: ESPRESSIF SYSTEMS (SHANGHAI) CO., LTD., Shanghai (CN)

(72) Inventors: Kedar SOVANI, Pune (IN); Sachin PAREKH, Pune (IN); Shubham PATIL, Pune (IN)

(21) Appl. No.: 18/725,098

(22) PCT Filed: Dec. 22, 2022
(86) PCT No.: PCT/CN2022/140887

§ 371 Date: Jun. 27, 2024

(30) Foreign Application Priority Data
Dec. 31, 2021 (IN) 202111062249

(51) Int. Cl. G06F 11/362

(52) U.S. Cl. CPC G06F 11/362

(57) ABSTRACT

A debugging method implemented by an IoT device, an IoT device, a debugging server, and a debugging system are disclosed. The IoT device is an MCU-based device with firmware running on it. The debugging method comprising the steps of: receiving a watchpoint configuration command sent by a debugging server, the watchpoint configuration command is used to configure a watchpoint, which at least comprises an address of the watchpoint to be configured and a debugging action to be executed once the watchpoint is triggered; parsing the watchpoint configuration command to identify the address and the corresponding debugging action; setting the watchpoint at a location corresponding to the address, so as to execute the corresponding debugging action once the set watchpoint is triggered during running of the firmware on the IoT device.

### TECHNICAL FIELD

The present disclosure relates to the field of Internet of Things (IoT) technology, and in particular to a debugging method for an IoT device, an IoT device, a debugging server, and a debugging system.

### BACKGROUND ART

An IoT device without a display usually packs a lot of software that enable Internet connectivity and local device control. Given the variance in terminal environments, debugging these IoT devices is a challenging task.

In the prior art, development teams usually have to spend enormous amount of time sifting through device data to establish hypotheses, and then provide firmware with diagnostic functions to prove or disprove these hypotheses. As each diagnostic program needs to go through rigorous quality assurance (QA) testing before being deployed to the device. Therefore, even if it is only deployed on a small number of devices, the debugging cycle still requires significantly larger amount of time, and the debugging process is relatively inefficient.

MCU-based IoT devices, such as devices that power smart bulbs, switches, air conditioners, washing machines, etc., usually have significantly constrained environments. These constraints make it difficult to implement rich diagnosis mechanism on the MCU (Micro-Controller Unit).

Therefore, how to achieve efficient and rich debugging diagnosis is one of the technical problems that the inventors of the present disclosure intend to solve.

It should be understood that the technical problems listed above are only examples rather than limitations to the present disclosure, and the present disclosure is not limited to technical solutions that simultaneously solve all the above technical problems. The technical solution of the present disclosure may be implemented to solve one or more of the above or other technical problems.

### SUMMARY OF THE INVENTION

In order to solve the above and other problems, this disclosure provides a debugging method implemented by an IoT device, the IoT device being an MCU-based device with firmware running thereon, the method comprising the steps of:
receiving a watchpoint configuration command sent by a debugging server, wherein the watchpoint configuration command is used to configure a watchpoint, and wherein the watchpoint configuration command at least comprises an address of the watchpoint to be configured and a debugging action to be executed once the watchpoint is triggered;
parsing the watchpoint configuration command to identify the address and the corresponding debugging action; and
setting the watchpoint at a location corresponding to the address, so as to execute the corresponding debugging action once the set watchpoint is triggered during running of the firmware on the IoT device.

Optionally, after parsing the watchpoint configuration command to identify the address and the corresponding debugging action, the method further comprises:
creating a data structure for identifying a correspondence between the address and the debugging action.

Optionally, the step of executing the corresponding debugging action once the set watchpoint is triggered comprises:
once the set watchpoint is triggered, identifying the address corresponding to the watchpoint; and
looking up the data structure for the debugging action corresponding to the address, and executing the corresponding debugging action.

Optionally, the debugging action is represented by a predefined action function, wherein the action function includes an action descriptor describing one or more actions to be executed.

Optionally, the debugging action is defined by an application executing in the debugging server.

Optionally, the debugging action further comprises a parameter that the debugging server is used to pass.

Optionally, the debugging action further comprises a debugging instruction that changes behavior of the firmware.

Optionally, the debugging instruction is a side-effect function.

Optionally, the side-effect function is a persistent side-effect function that is retained across power-cycles of the firmware.

Optionally, the debugging action is configured persistently which is retained across reboots.

Optionally, the watchpoint configuration command is a command in a predetermined JSON or CBOR format.

Optionally, after parsing the watchpoint configuration command to identify the address, the method further comprises:
based on the address of the watchpoint, determining whether a previously set watchpoint exists at the address which the watchpoint is to be set, and if so, clearing the previously set watchpoint at the corresponding address.

Optionally, the watchpoint is an instruction watchpoint or a data watchpoint; wherein the corresponding instruction watchpoint is triggered when an instruction at the address is executed; and the corresponding data watchpoint is triggered when data at the address is accessed.

Optionally, the IoT device receives commands sent by the debugging server through a runtime library with a single thread of execution.

Optionally, after the set watchpoint is triggered during running of the firmware on the IoT device, the method further comprises:
setting the set watchpoint to a disabled state.

Optionally, after executing the corresponding debugging action, the method further comprises:
determining whether the set watchpoint is a sticky watchpoint;
if yes, and if the IoT device supports hardware single stepping,
   enabling hardware single stepping and returning, so as to return to resume execution from the set watchpoint and generating a single step interrupt; and inside single step interrupt, re-enabling the set watchpoint and disabling further single stepping;
   and if the IoT device does not support hardware single stepping,
   setting a provisional breakpoint at an instruction next to an instruction corresponding to the set watchpoint, so as to return to resume execution from the set watchpoint until the provisional breakpoint is triggered, thereby executing a same debugging action as the set watchpoint is triggered; and
if not, clearing the debugging action corresponding to the set watchpoint.

Optionally, after executing the corresponding debugging action, the method further comprises:
reporting diagnostic data obtained after executing the corresponding debugging action to the debugging server.

Optionally, the step of reporting the diagnostic data to the debugging server is performed asynchronously.

This disclosure also provides a debugging method for an IoT device, implemented by a debugging server, the IoT device being an MCU-based device with firmware running thereon, the method comprises:
receiving, from a developer, a configuration request for debugging the firmware of the IoT device;
generating a watchpoint configuration command based on the configuration request, wherein the watchpoint configuration command is used to configure a watchpoint, wherein the watchpoint configuration command at least comprises an address of the watchpoint to be configured and a debugging action to be executed once the watchpoint is triggered; and
sending the watchpoint configuration command to an IoT device, so that after the IoT device receives the watchpoint configuration command, parses the watchpoint configuration command to identify the address and the corresponding debugging action, sets the corresponding watchpoint at the address, and once the set watchpoint is triggered during running of the firmware on the IoT device, executes the corresponding debugging action.

The present disclosure also provides an IoT device, comprising a memory and a processor, wherein the memory is configured to store instructions, and the instructions, when executed by the processor, implement the above-mentioned method.

The present disclosure also provides a debugging server, comprising a memory and a processor, wherein the memory is configured to store instructions, and the instructions, when executed by the processor, implement the above-mentioned method.

The present disclosure also provides a debugging system, comprising the above-mentioned IoT device and the above-mentioned debugging server.

Optionally, the MCU of the IoT device has a flat address space.

Optionally, system of the MCU has no user-kernel separation, so a runtime library runs in a same context as an operating system and a network stack of the system.

Optionally, the debugging server comprises: a developer front-end and a server back-end;
wherein the developer front-end is configured to receive a configuration request from a developer for debugging the firmware of the IoT device, and to send the configuration request to the server back-end; and the server back-end is configured to generate the watchpoint configuration command based on the configuration request.

Optionally, the debugging server is a cloud server.

Optionally, the IoT device supports parameter-based command handling, and is a subscriber of a MQTT (Message Queuing Telemetry Transport) topic that receives commands from the debugging server.

Optionally, the debugging server and the IoT device exchange information over MQTT.

The debugging method implemented by an IoT device, the IoT device being an MCU-based device with firmware running thereon. By receiving the watchpoint configuration command sent by the debugging server, the watchpoint configuration command is used to configure the watchpoint, wherein the watchpoint configuration command at least comprises the address of the watchpoint to be configured and the debugging action to be executed once the watchpoint is triggered. Parsing the watchpoint configuration command to identify the address and the corresponding debugging action. Setting the watchpoint at a location corresponding to the address, so as to execute the corresponding debugging action once the set watchpoint is triggered during running of the firmware on the IoT device. The debugging method provided in this disclosure implemented by an MCU-based IoT device, enable remote debugging by setting a watchpoint on the firmware running on the device. The method is not limited by the device's own resources, and may realize rich diagnostic functions. And developers may avoid the long and time-consuming process of building, testing, and deploying firmware on the device, making the debugging process more efficient. In addition, the present disclosure also provides an IoT device, a debugging server, and a debugging system, which may also achieve the above technical effects.

### BRIEF DESCRIPTION OF THE DRAWINGS

Hereinafter, the present disclosure will be further explained based on the embodiments with reference to the drawings.

FIG. 1 schematically shows a schematic structural diagram of the debugging system provided by the present disclosure;

FIG. 2 schematically shows a working flow chart of the debugging system provided by the present disclosure;

FIG. 3 schematically shows a flowchart of a specific implementation of the debugging method implemented by an IoT device provided by the present disclosure;

FIG. 4 schematically shows a flowchart of the process of setting a watchpoint in the debugging method implemented by an IoT device provided by the present disclosure;

FIG. 5 schematically shows a flowchart of the process of executing the debugging action in the debugging method implemented by an IoT device provided by the present disclosure;

FIG. 6 schematically shows a structural block diagram of the IoT device provided by this disclosure;

FIG. 7 schematically shows a flowchart of another specific implementation of the debugging method implemented by an IoT device provided by the present disclosure; and

FIG. 8 schematically shows a structural block diagram of the debugging server provided by the present disclosure.

### DETAILED DESCRIPTION OF THE PREFERRED EMBODIMENTS

The method and device of the present disclosure will be described in detail below with reference to the drawings and specific embodiments. It should be understood that the embodiments shown in the drawings and described below are merely illustrative, and are not intended to limit the application.

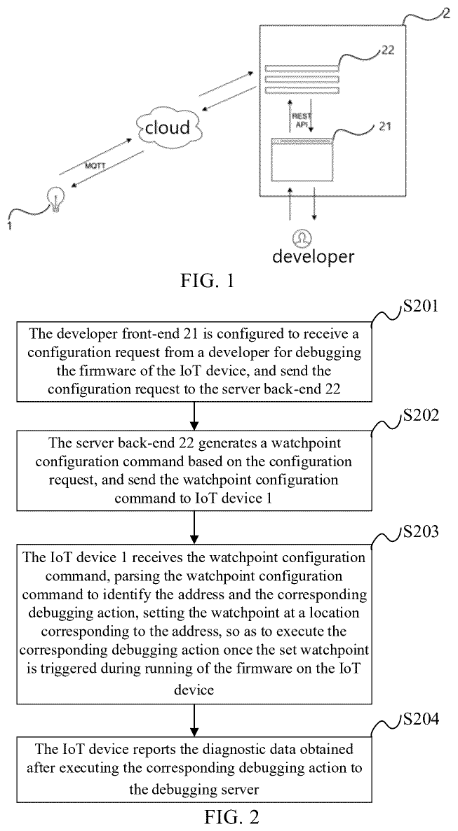

FIG. 1 shows a schematic structural diagram of the debugging system provided by the present disclosure. The debugging system comprising an IoT device 1 and a debugging server 2.

The debugging server 2 may be a cloud server. The debugging server 2 may specifically comprises a developer front end 21 and a server back end 22. Here, the developer front end 21 is configured to receive a configuration request from a developer for debugging the firmware of the IoT device, and to send the configuration request to the server back-end 22; and the server back-end 22 is configured to generate the watchpoint configuration command based on the configuration request.

Optionally, the developer front end 21 may provide an interactive interface for specific options, and the developer may make selections through the interactive interface and a configuration request is generated.

The IoT device is an MCU-based device with firmware running on it. As a specific implementation, the MCU of the IoT device has a flat address space. The system of the MCU has no user-kernel separation, so a runtime library runs in a same context as an operating system and a network stack of the system, which increases the complexity of debugging.

The architecture of this disclosure supports the watchpoint register, and when the watchpoint is triggered, a fault/exception is triggered. When such a fault/exception is triggered, debugging actions may be executed, and execution may be returned to the original instruction without changing the execution of the original instruction.

Specifically, the watchpoint may be an instruction watchpoint or a data watchpoint; wherein the corresponding instruction watchpoint is triggered when an instruction at the address is executed; and the corresponding data watchpoint is triggered when data at the address is accessed.

The IoT devices usually have a cloud backlink for accepting remote control instructions from end users, and generally exchange information through MQTT, a message transfer protocol. In some embodiments of the present disclosure, the IoT device supports parameter-based command handling, which allows it to accept commands from the debugging server. The IoT device exposes, for example, the API of “set watchpoint” to a debugging server located in the cloud, and the watchpoint configuration command may be executed by the debugging server by sending JSON encoded data on the MQTT topic. The IoT device may be a subscriber of the MQTT topic that receives commands from the debugging server. The debugging server and the IoT device exchange information over MQTT.

The IoT device receives commands sent by the debugging server through a runtime library with a single thread of execution. The runtime library is responsible for receiving a list of command(s) from the MQTT topic, and using the coding method provided in this disclosure to parse the relevant action descriptor from the command.

The current mature debugging tools mainly adopt dynamic debugging methods. However, conventional dynamic debugging requires information interaction between the debugging tool and the program to be tested at runtime, which will cause numerous running costs, and rich interface support of the operating system. Therefore, in the case of limited hardware resources and rare software interfaces, it is difficult to apply the dynamic debugging method to IoT devices. Moreover, in the case of IoT devices, the debugging tool may be a remote browser running on the developer's desktop, while the IoT device is generally installed in the user's home, that is, the debugging tool and the IoT device are likely to be on different networks. This also limits the information that may be exchanged between the debugging targets and the debugging tools.

The MCU-based IoT device of this disclosure realizes remote debugging by setting watchpoints on the firmware running on the device, which is not limited by the device's own resources and may realize rich diagnostic functions. And developers may avoid the long and time-consuming process of building, testing, and deploying firmware on the device, making the debugging process more efficient. In addition, the choice of the protocol between the IoT device and the debugging server may be in a way such that the existing cloud connectivity (that most IoT devices have), may be leveraged, instead of having to set up a dedicated and expensive cloud connection for debugging.

FIG. 2 shows a working flow chart of the debugging system provided by this disclosure. Referring to FIG. 2, the process comprises:

S201: The developer front-end 21 is configured to receive a configuration request from a developer for debugging the firmware of the IoT device, and send the configuration request to the server back-end 22.

In the embodiment of the present disclosure, the developer has access to an ELF (Executable and Linkable Format) file that corresponds to the binary executable file running on the IoT device, and the developer may select the address of any variable or function that are relevant from the ELF file. Then it is coded through the server back-end to generate a watchpoint configuration command.

As an example, the developer wants to obtain whether a particular code path is taken during the execution in the IoT device, and if so, the developer may further want to know the value of the particular variable “my_variable”. The developer may use the developer front end 21 to configure in order to determine whether the execution hit this specific code. In addition, the developers may also configure the address of the variable “my_variable” to be reported to the debugging server. The diagnostic event may be named “event123”, for example. The developer front-end 21 may generate a configuration request based on such information, and send the configuration request to the server back-end 22.

S202: The server back-end 22 generates a watchpoint configuration command based on the configuration request, and send the watchpoint configuration command to IoT device 1.

As a specific implementation, the server back-end 22 may receive the configuration request over a REST API from the developer front-end 21. The configuration request may be for one device or a group of devices. Based on the configuration request, the server back-end 22 generates a watchpoint configuration command, and sends the watchpoint configuration command to one or more IoT devices 1. Specifically, the server back-end 22 may directly exchange information with the IoT device 1 over MQTT.

As a specific implementation, the watchpoint configuration command may be a command in a predetermined JSON or CBOR format.

As an example, the watchpoint configuration command may be:

```
“cmds”: [
    “sw”: {“p1”: “value1”, “p2”:“value2”}
  ]
}
```

Here, the “sw” parameter indicates the type of command, which is used to indicate the “set watchpoint” command, p1 and p2 are the two parameters included in the command, and value1 corresponds to a defined value for p1, and value2 corresponds to a defined value for p2. Specifically in this embodiment, p1 means the address “addr” of watchpoint to be set, and p2 means the debugging action “func” that is executed once the watchpoint is triggered.

It can be understood that this embodiment uses JSON (JavaScript Object Notation) to showcase the watchpoint configuration command. Of course, CBOR (Concise Binary Object Representation) or any other suitable format may also be used, which is not limited here.

S203: The IoT device 1 receives the watchpoint configuration command, parsing the watchpoint configuration command to identify the address and the corresponding debugging action, setting the watchpoint at a location corresponding to the address, so as to execute the corresponding debugging action once the set watchpoint is triggered during running of the firmware on the IoT device.

After the IoT device 1 receives the watchpoint configuration command, performs appropriate configuration in the execution environment, and sets the watchpoint at the location corresponding to the address based on the resolved address and the debugging action. Once the set watchpoint is triggered during running of the firmware, the corresponding debugging action will be executed. After the debugging action is executed, the system continues to operate normally until any set watchpoint is triggered.

For example, in the case of the above example, on receipt of the watchpoint configuration command, the IoT device 1 may execute a watchpoint configuration program that is pre-registered on the device. The watchpoint configuration program is executed based on the two parameters in the watchpoint configuration command: p1 and p2 and the corresponding defined value.

S204: The IoT device reports the diagnostic data obtained after executing the corresponding debugging action to the debugging server.

Whenever the set watchpoint is triggered, the corresponding debugging action is executed. The diagnostic data obtained after executing the corresponding debugging action is reported to the debugging server. It can be understood that the step of reporting may be performed asynchronously. That is, the obtained diagnostic data will await its turn based on the policy of the device, and is queued to be sent to the debugging server. Whenever the IoT device gets a chance, the diagnostic data will be reported to the debugging server located in the cloud over MQTT, and the rest of execution will continue to be executed normally on the device.

The server back-end 22 may collect and maintain all the diagnostic data reported by the IoT device. Developers may use the REST (RESTful) API to access the diagnostic data stored in the back end of the server through the developer front-end 21, and query the diagnostic events that occur on the IoT device.

The embodiments of the present disclosure provide a complete end-to-end system, from cloud server that usually IoT device communicate to, to the firmware running on the IoT device. The MCU-based IoT device realizes remote debugging by setting watchpoint on the firmware running on the device, which is not limited by the device's own resources and may realize rich diagnostic functions. And developers may avoid the long and time-consuming process of building, testing, and deploying firmware on the device, making the debugging process more efficient.

As a specific implementation, the debugging action may be represented by a predefined action function, and the action function includes an action descriptor describing the action to be executed.

For example, the embodiment of this disclosure may define the following commands:

```
• action:
  -f /* Execute function′f′ */
• f:
  -0xabcd1234 /* An arbitrary address to execute from# */
  -esp_exec(n, f1, f2, ..., fn) /* Execute ‘n’ functions one after the other*/
  -esp_cntdwn(cnt, f) /* Countdown from cnt and execute ‘f’ on zero */
  -esp_onesht(f) /* Execute f and remove watchpoint */
  -esp_evt_str(e, ″str″) /* Report event e1 with data ‘str’ to the cloud */
  -esp_evt(e, address, length) /* Report event e1 with ‘length’ bytes of data
starting from ‘address’ */
  -esp_incr(address) /* Increment 32-byte integer value at ‘address’ by 1*/
  -esp_set(address, value) /* Write the ‘value’ at ‘address’ */
  -esp_task_info( ) /* Report information about current thread/stack */
  -esp_task_snpsht ( ) /* Report information about all thread/stacks*/
• n:
  -Numbers of 0 to 9
• cnt, length:
  -Positive integer
• e:
  -Diagnostic event
• address:
  -An addressable memory location from the device
• value:
  -Bit string
```

Based on the definition of the above action descriptor, the action function may be coded as:

```
{
    “f”: “evt str”,
    “param”: [
      “eventX”,
      “string1”
    ]
  }
```

where the parameters in themselves could be functions, so hence this could be recursive.

The watchpoint configuration command may be coded as:

```
{
  “cmds”: [
    {
      “sw”: {
        “addr”: 3492939533,
        “func”: {
          “f”: “cntdwn”,
          “param”: [
            20,
            {
              “f”: “evt_str”,
              “param”: [
                “eventX”,
                “string1”
              ]
            }
          ]
        }
      }
    }
  ]
}
```

In the above example, the command specifically means: a watchpoint should be set at address 3492939533 to execute the esp_cntdwn function from 20 (that is, countdown from 20 and execute on zero), and upon reaching 0, the function esp_evt_str with parameters eventX and string1 should be executed (that is, report event eventX with data “string1” to the cloud).

The esp_cntdwn, esp_evt_str and other functions described above are called action functions. As a specific implementation, these functions may be maintained in a lookup table indexed by the JSON strings received in the command. The above action descriptors and action functions define the exact steps to be taken to perform debugging. It can be understood that the “cmds” command is an array, which may contain multiple commands. Once set, the runtime library of the IoT device will process these commands sequentially, and multiple watchpoints may be set at the same time. Therefore, multiple watchpoints may be active during the debugging process. Once any one of the set watchpoints is triggered, the corresponding debugging action will be executed.

The debugging actions described by some action functions may cause security problems. For example, functions that allow execution from any location may be disabled in the firmware if the developer is not trusted.

It is understandable that these functions will be executed in the context of the handler, so there cannot be too much complex code. This disclosure may keep the exchanged information to a minimum with compact encoding, and may quickly complete debugging with as few instructions as possible. Moreover, the command may be directly linked to the test code.

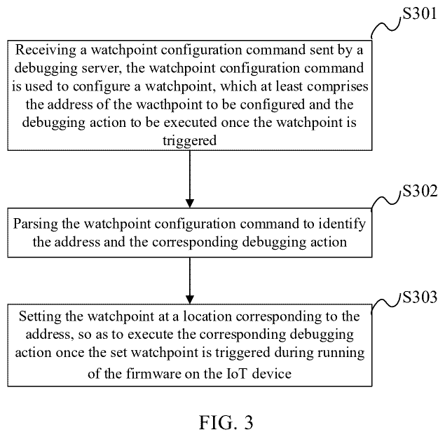

FIG. 3 shows a flowchart of a specific implementation of a debugging method for an IoT device provided by the present disclosure. The method is implemented to an IoT device, which is an MCU-based device with firmware running on it. The method specifically includes:

S301: receiving a watchpoint configuration command sent by a debugging server, the watchpoint configuration command is used to configure a watchpoint, which at least comprises the address of the watchpoint to be configured and the debugging action to be executed once the watchpoint is triggered.

S302: parsing the watchpoint configuration command to identify the address and the corresponding debugging action.

S303: setting the watchpoint at a location corresponding to the address, so as to execute the corresponding debugging action once the set watchpoint is triggered during running of the firmware on the IoT device.

Specifically, the watchpoint in the embodiment of the present disclosure may be an instruction watchpoint or a data watchpoint. The corresponding instruction watchpoint is triggered when the instruction at the address is executed; and the corresponding data watchpoint is triggered when data at the address is accessed.

The conventional watchpoint is usually used for software debugging, but once the watchpoint is triggered, the execution will stall. Then the developer may study the memory and registers of the device, try to understand the state of the device, and explore the cause of the problem being triggered. But for this disclosure to realize remote debugging, the conventional watchpoints are not feasible. Because if the watchpoint is triggered and the device stalls, it cannot upload data to the remote debugging server. Therefore, by setting of the watchpoint configuration command in this disclosure, after the set watchpoint is triggered, one or more actions defined in the watchpoint configuration command may be executed to realize remote debugging, without being restricted by the device's own resources, and also achieve rich diagnostic functions. And developers may avoid the long and time-consuming process of building, testing, and deploying firmware on the device, making the debugging process more efficient.

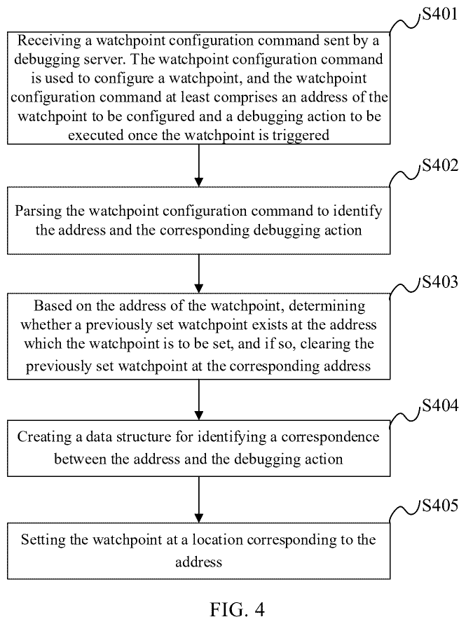

FIG. 4 shows a flowchart of the process of setting a watchpoint in the debugging method implemented by an IoT device provided by the present disclosure. The method specifically comprises:

S401: receiving a watchpoint configuration command sent by a debugging server. The watchpoint configuration command is used to configure a watchpoint, and the watchpoint configuration command at least comprises an address of the watchpoint to be configured and a debugging action to be executed once the watchpoint is triggered.

S402: parsing the watchpoint configuration command to identify the address and the corresponding debugging action.

S403: based on the address of the watchpoint, determining whether a previously set watchpoint exists at the address which the watchpoint is to be set, and if so, clearing the previously set watchpoint at the corresponding address.

S404: creating a data structure for identifying a correspondence between the address and the debugging action.

Through the created data structure, the corresponding debugging action may be easily obtained by querying the address in the data structure later.

S405: setting the watchpoint at a location corresponding to the address.

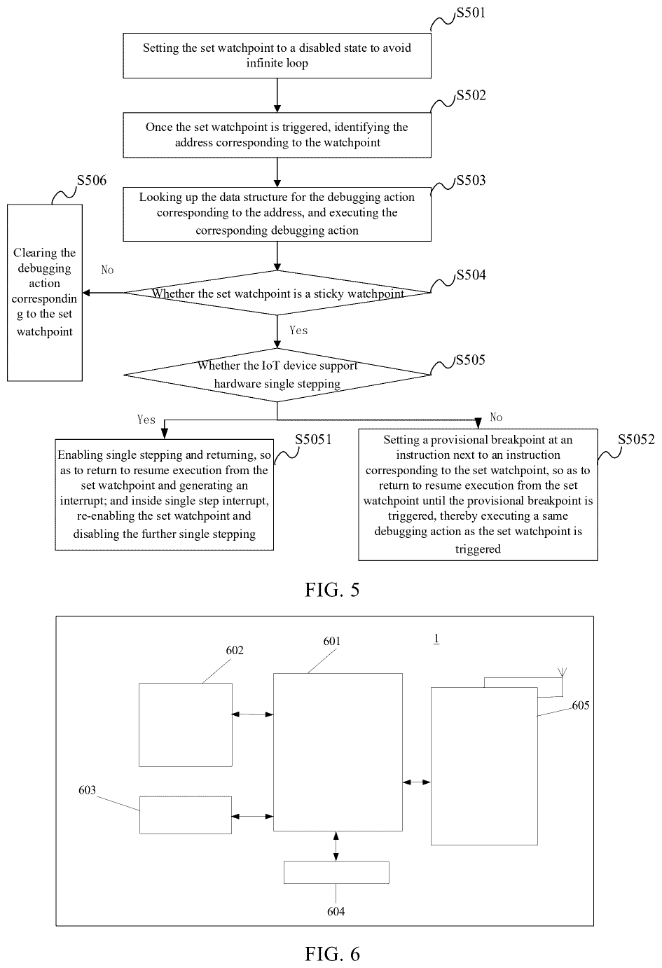

FIG. 5 shows a flow chart of the process of executing the debugging action in the debugging method implemented by an IoT device provided by the present disclosure. Referring to FIG. 5, once the set watchpoint is triggered, the following operations are executed:

S501: setting the set watchpoint to a disabled state to avoid infinite loop.

S502: once the set watchpoint is triggered, identifying the address corresponding to the watchpoint.

S503: looking up the data structure for the debugging action corresponding to the address, and executing the corresponding debugging action.

S504: when the debugging action returns from execution, determining whether the set watchpoint is a sticky watchpoint; if yes, go to S505; if not, go to S506:

S505: determining whether the IoT device supports hardware single stepping, if yes, go to S5051; if not, go to S5052.
S5051: enabling hardware single stepping and returning, so as to return to resume execution from the set watchpoint and generating a single step interrupt; and inside the single step interrupt, re-enabling the set watchpoint and disabling further single stepping.
S5052: setting a provisional breakpoint at an instruction next to an instruction corresponding to the set watchpoint, so as to return to resume execution from the set watchpoint until the provisional breakpoint is triggered, thereby executing a same debugging action as the set watchpoint is triggered.

S506: clearing the debugging action corresponding to the set watchpoint.

It is understandable that in the embodiments of this disclosure, the “sticky” is used to indicate whether the watchpoint is a single-triggered watchpoint (triggered only once) or a frequent watchpoint (triggered more than once).

As a specific implementation, a maximum number of supported invocations may be set for the watchpoint, for example, 100 invocations.

After executing the corresponding debugging action, the embodiment of this disclosure further comprises: reporting diagnostic data obtained after executing the corresponding debugging action to the debugging server. The step of reporting the diagnostic data to the debugging server may be performed asynchronously.

It is understandable that the debugging actions may be pre-defined rules, or they may be customized and generated by an application running on the debugging server. The debugging server or the user may decide which specific debugging actions should be specified.

In addition, the debugging action also includes parameters. For example, a debugging action may be: when the watchpoint is triggered, update the variable x with the value y. Here, x and y are the parameters of the debugging action. It is understandable that some debugging actions may not contain parameters. The debugging server is used to pass the parameters of the debugging action.

The debugging actions may further comprise a debugging instruction that changes behavior of the firmware. Optionally, the debugging instruction may be a side-effect function, i.e., function with side effects. With side effects means changing the behavior of the system in a specific way. Further, the side-effect function may be a persistent side-effect function that is retained across power-cycles of the firmware.

Optionally, the debugging action may be configured persistently which is retained across reboots.

Corresponding to the above method, this disclosure also provides an IoT device 1. Referring to FIG. 6 showing a structural block diagram of the IoT device provided by this disclosure, the IoT device 1 may include one or more of the following components: a processor 601, a memory 602, a power supply component 603, an input/output (I/O) interface 604, and a communication component 605.

The processor 601 generally controls overall operations of the IoT device 1, such as operations associated with display, phone call, data communication, camera operations, and recording operations. The processor 601 may call the instructions stored in the memory 602 to complete all or part of the steps of the above-mentioned method.

The memory 602 is configured to store various types of data to support the operation of the IoT device 1. Examples of these data include instructions, contact data, phone book data, messages, pictures, videos, and the like for any application or method operating on the IoT device 1. The memory 602 may be implemented by any type of volatile or non-volatile storage device or their combination, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 603 provides power for various components of the IoT device 1. The power supply component 603 may include a power management system, one or more power supplies, and other components associated with generating, managing, and distributing power for the IoT device 1.

The input/output (I/O) interface 604 provides an interface between the processor 601 and peripheral interface modules. The peripheral interface modules may be a keyboard, a click wheel, a button, and the like. These buttons may include but are not limited to: home button, volume button, start button, and lock button.

The communication component 605 is configured to facilitate wired or wireless communication between the IoT device 1 and other devices. The IoT device 1 may access a wireless network based on a communication standard, such as Wi-Fi, 2G, or 3G, or a combination thereof.

In an exemplary embodiment, the IoT device 1 may be implemented by one or more application specific integrated circuits (ASIC), digital signal processors (DSP), digital signal processing devices (DSPD), programmable logic devices (PLD), field programmable gate array (FPGA), controller, microcontroller, microprocessor or other electronic components to perform the above methods.

It is understandable that the IoT device provided in this disclosure corresponds to the above-mentioned debugging method implemented by the IoT device, and its specific implementation may be referred to the above content, which will not be repeated here.

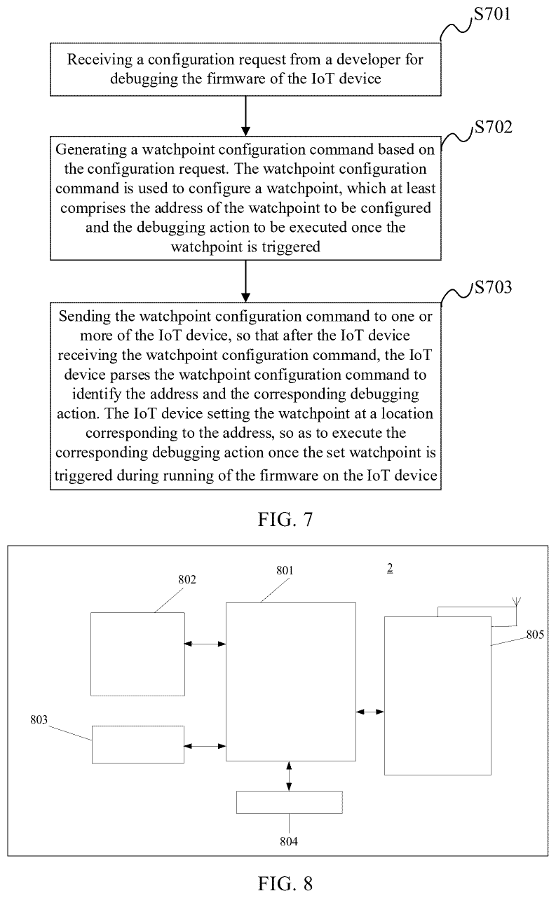

In addition, this disclosure also provides a debugging method implemented by a debugging server, and an IoT device is an MCU-based device with firmware running on it. As shown in FIG. 7, which shows a flowchart of another specific implementation of the debugging method implemented by an IoT device provided by the present disclosure, the method includes:

S701: receiving a configuration request from a developer for debugging the firmware of the IoT device.

S702: generating a watchpoint configuration command based on the configuration request. The watchpoint configuration command is used to configure a watchpoint, which at least comprises the address of the watchpoint to be configured and the debugging action to be executed once the watchpoint is triggered.

S703: sending the watchpoint configuration command to one or more of the IoT device, so that after the IoT device receiving the watchpoint configuration command, the IoT device parses the watchpoint configuration command to identify the address and the corresponding debugging action. The IoT device setting the watchpoint at a location corresponding to the address, so as to execute the corresponding debugging action once the set watchpoint is triggered during running of the firmware on the IoT device.

Corresponding to the above method, the present disclosure also provides a debugging server. Referring to FIG. 8 showing a structural block diagram of the debugging server provided by the present disclosure, the debugging server 2 may include one or more of the following components: a processor 801, a memory 802, a power supply component 803, an input/output (I/O) interface 804, and a communication component 805.

The processor 801 generally controls the overall operation of the debugging server 2. The processor 801 may call the instructions stored in the memory 802 to complete all or part of the steps of the above-mentioned methods.

The memory 802 is configured to store various types of data to support the operation of the debugging server 2. Examples of these data include instructions, contact data, phone book data, messages, pictures, videos, and the like, for any application or method operating on the debugging server 2. The memory 802 may be implemented by any type of volatile or non-volatile storage device or their combination, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 803 provides power for various components of the debugging server 2. The power supply component 803 may include a power management system, one or more power supplies, and other components associated with generating, managing, and distributing power for the debugging server 2.

The input/output (I/O) interface 804 provides an interface between the processor 801 and peripheral interface modules. The peripheral interface modules may be a keyboard, a click wheel, a button, and the like. These buttons may include but are not limited to home button, volume button, start button, and lock button.

The communication component 805 is configured to facilitate wired or wireless communication between the debugging server 2 and other devices. The debugging server 2 may be connected to a wireless network based on a communication standard, such as Wi-Fi, telecommunication standards, or a combination thereof. It is understandable that the debugging server provided in this disclosure corresponds to the above-mentioned debugging methods, and the specific implementation may be referred to the above-mentioned content, which will not be repeated here.

Although various embodiments of various aspects of the present disclosure have been described for the purpose of the present disclosure, it should not be understood that the teachings of the present disclosure are limited to these embodiments. The features disclosed in a specific embodiment are not limited to this embodiment, but may be combined with features disclosed in different embodiments. For example, one or more features and/or operations of the method according to the present disclosure described in one embodiment may also be applied in another embodiment individually, in combination or as a whole. Those skilled in the art should understand that there are more possible alternative implementations and modifications, and various changes and modifications may be made to the above system without departing from the scope defined by the claims of the present disclosure.

1. A debugging method implemented by an IoT device, the IoT device being an MCU-based device with firmware running thereon, the method comprising the steps of:
receiving a watchpoint configuration command sent by a debugging server, wherein the watchpoint configuration command is used to configure a watchpoint, and wherein the watchpoint configuration command at least comprises an address of the watchpoint to be configured and a debugging action to be executed once the watchpoint is triggered;
parsing the watchpoint configuration command to identify the address and the corresponding debugging action; and
setting the watchpoint at a location corresponding to the address, so as to execute the corresponding debugging action once the set watchpoint is triggered during running of the firmware on the IoT device.

2. The debugging method according to claim 1, wherein after parsing the watchpoint configuration command to identify the address and the corresponding debugging action, the method further comprises:
creating a data structure for identifying a correspondence between the address and the debugging action.

3. The debugging method according to claim 2, wherein the step of executing the corresponding debugging action once the set watchpoint is triggered comprises:
once the set watchpoint is triggered, identifying the address corresponding to the watchpoint; and
looking up the data structure for the debugging action corresponding to the address, and executing the corresponding debugging action.

4. The debugging method according to claim 1, wherein the debugging action is represented by a predefined action function, wherein the action function includes an action descriptor describing one or more actions to be executed.

5. The debugging method according to claim 1, wherein the debugging action is defined by an application executing in the debugging server.

6. The debugging method according to claim 1, wherein the debugging action further comprises a parameter that the debugging server is used to pass.

7. The debugging method according to claim 1, wherein the debugging action further comprises a debugging instruction that changes behavior of the firmware.

8. The debugging method according to claim 7, wherein the debugging instruction is a side-effect function.

9. The debugging method according to claim 8, wherein the side-effect function is a persistent side-effect function that is retained across power-cycles of the firmware.

10. The debugging method according to claim 7, wherein the debugging action is configured persistently which is retained across reboots.

11. The debugging method according to claim 4, wherein the watchpoint configuration command is a command in a predetermined JSON or CBOR format.

12. The debugging method according to claim 11, wherein after parsing the watchpoint configuration command to identify the address, the method further comprises: based on the address of the watchpoint, determining whether a previously set watchpoint exists at the address which the watchpoint is to be set, and if so, clearing the previously set watchpoint at the corresponding address.

13. The debugging method according to claim 1, wherein the watchpoint is an instruction watchpoint or a data watchpoint; wherein the corresponding instruction watchpoint is triggered when an instruction at the address is executed; and the corresponding data watchpoint is triggered when data at the address is accessed.

14. The debugging method according to claim 1, wherein the IoT device receives commands sent by the debugging server through a runtime library with a single thread of execution.

15. The debugging method according to claim 1, wherein after the set watchpoint is triggered during running of the firmware on the IoT device, the method further comprises:
setting the set watchpoint to a disabled state.

16. The debugging method according to claim 1, wherein after executing the corresponding debugging action, the method further comprises:
determining whether the set watchpoint is a sticky watchpoint;
if yes, and if the IoT device supports hardware single stepping,
enabling hardware single stepping and returning, so as to return to resume execution from the set watchpoint and generating a single step interrupt; and inside the single step interrupt, re-enabling the set watchpoint and disabling further single stepping;
and if the IoT device does not support hardware single stepping,
setting a provisional breakpoint at an instruction next to an instruction corresponding to the set watchpoint, so as to return to resume execution from the set watchpoint until the provisional breakpoint is triggered, thereby executing a same debugging action as the set watchpoint is triggered; and
if not, clearing the debugging action corresponding to the set watchpoint.

17. The debugging method according to claim 1, wherein after executing the corresponding debugging action, the method further comprises:
reporting diagnostic data obtained after executing the corresponding debugging action to the debugging server.

18. The debugging method according to claim 1, wherein the step of reporting the diagnostic data to the debugging server is performed asynchronously.

19. A debugging method for an IoT device, implemented by a debugging server, the IoT device being an MCU-based device with firmware running thereon, wherein the method comprises:
receiving, from a developer, a configuration request for debugging the firmware of the IoT device;
generating a watchpoint configuration command based on the configuration request, wherein the watchpoint configuration command is used to configure a watchpoint, wherein the watchpoint configuration command at least comprises an address of the watchpoint to be configured and a debugging action to be executed once the watchpoint is triggered; and
sending the watchpoint configuration command to an IoT device, so that after the IoT device receives the watchpoint configuration command, parses the watchpoint configuration command to identify the address and the corresponding debugging action, sets the corresponding watchpoint at the address, and once the set watchpoint is triggered during running of the firmware on the IoT device, executes the corresponding debugging action.

20. An IoT device, comprising a memory and a processor, wherein the memory is configured to store instructions, and the instructions, when executed by the processor, implement steps of:
receiving a watchpoint configuration command sent by a debugging server, wherein the watchpoint configuration command is used to configure a watchpoint, and wherein the watchpoint configuration command at least comprises an address of the watchpoint to be configured and a debugging action to be executed once the watchpoint is triggered;
parsing the watchpoint configuration command to identify the address and the corresponding debugging action; and
setting the watchpoint at a location corresponding to the address, so as to execute the corresponding debugging action once the set watchpoint is triggered during running of the firmware on the IoT device.

21.-28. (canceled)
